(19) United States
(12) Patent Application Publication
(10) Pub. No.: US 2006/0258267 A1
(43) Pub. Date: Nov. 16, 2006

(54) Polishing composition and polishing method using same

(76) Inventors: Takashi Ito, Gifu-shi (JP); Tetsuji Hori, Saku-shi (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/569,906

(22) PCT Filed: Aug. 27, 2004
(86) PCT No.: PCT/JP04/12347

§ 371 Date: Feb. 27, 2006

(30) Foreign Application Priority Data
Aug. 27, 2003 (JP) 2003-303694

(51) Int. Cl. B24D 3/02; B24B 7/30; C09K 3/14; B24B 1/00

(52) U.S. Cl. 451/41; 51/309; 51/308

(57) ABSTRACT

A polishing composition of the present invention contains cerium oxide abrasive grains with surfaces having an adsorption layer formed by adsorption of silicon oxide fine grains. The polishing composition is used in an application for polishing a polishing subject including a laminated body and a silicon oxide film arranged on the laminated body. The laminated body has a semiconductor substrate formed from a monocrystalline silicon or a polycrystalline silicon, a silicon nitride film arranged on the semiconductor substrate, and a surface with grooves. The polishing composition removes a portion of the silicon oxide film located outside the groove.

### TECHNICAL FIELD

The present invention relates to a polishing composition used in polishing to form an element isolation structure in a semiconductor device and a polishing method using the same.

### BACKGROUND ART

An element isolation structure for a semiconductor device has been formed through a method (local oxidation of silicon (LOCOS) process) for selectively and directly oxidizing an isolation region, which is portions other than those that become elements of a semiconductor substrate, such as silicon wafer. However, there has been a recent demand for a more planar surface due to the higher integration of wiring and the multi-layering of a wiring layer. Thus, there is an increasing number of cases in which after selectively removing the isolation region on a silicon wafer through etching, a silicon oxide film is grown through a chemical vapor deposition process (CVD process), and the silicon oxide film on an element is selectively removed through chemical mechanical polishing (CMP). This process is referred to as a STI (shallow trench isolation)-CMP process. In the STI-CMP process, it is important that an initial step is eliminated and that polishing be terminated at a silicon nitride film, which is formed as a protective film and a polishing stopping film on the element. In the STI-CMP process, the polishing composition in which the ratio of the speed for polishing the silicon oxide film with respect to the speed for polishing the silicon nitride film is about two to three in the prior art. In other words, the polishing composition has the capacity to polish the silicon oxide film with a selectivity of two to three times with respect to the silicon nitride film.

A process for growing an inter-layer dielectric film on a wiring layer of a silicon wafer through the CVD method, polishing the surface of the inter-layer dielectric film, and then forming the next wiring layer thereon to laminate a plurality of wiring layers on the silicon wafer is known. This process is referred to as an ILD (inter-layer dielectric)-CMP process. In the ILD-CMP process, the polishing composition produced by adding ammonia or potassium hydroxide to a water dispersion liquid of fumed silica is used in the prior art.

When polishing of the STI-CMP process is performed using the polishing composition conventionally used in the ILD-CMP process, an initial step is not sufficiently eliminated and polishing is not completely stopped at the silicon nitride film. Thus, the silicon nitride film does not function as the polishing stopping film. Consequently, a phenomenon referred to as dishing in which the thickness of the silicon oxide film in the isolation region selectively decreases, or a phenomenon referred to as erosion in which the high density part is selectively over-polished occurs. Thus, a satisfactory isolation structure cannot be formed. To resolve such a problem, an etching back step for selectively etching the silicon oxide film on an element to a certain extent must be performed before the polishing to reduce the initial step in advance.

Recently, a polishing composition containing cerium oxide abrasive grains and having the capacity to polish a silicon oxide film with a selectivity of ten times or greater relative to the silicon nitride film may in some cases be used in the STI-CMP process to omit the etching back step. However, cerium oxide abrasive grains have a very high specific gravity and thus have a high sedimentation velocity. The polishing composition containing cerium oxide abrasive grains is thus likely to cause precipitation and solidification, and the handling thereof is not satisfactory. Further, the polished wafer cannot be easily washed since the cerium oxide abrasive grains are very easily adsorbed by the silicon oxide film. In addition, cerium oxide abrasive grains have a tendency to easily produce polishing scratches compared to silicon oxide abrasive grains. Further, the extent of contribution of cerium oxide abrasive grains to eliminating the steps on the surface of the wafer is almost the same as that of the conventional silicon oxide abrasive grains, and cerium oxide abrasive grains thus does not contribute much to suppressing the occurrence of dishing.

The polishing composition containing cerium oxide abrasive grains has an advantage in that the speed for polishing the silicon oxide film is high compared to the polishing composition containing silicon oxide abrasive grains. Therefore, the polishing composition containing cerium oxide abrasive grains may be used in the ILD-CMP process as long as the above problems can be solved.

Patent Publication 1 describes a polishing composition containing silicon oxide abrasive grains and cerium oxide abrasive grains to improve handling, to improve washing, and to improve the speed for polishing a subject polishing film. Patent Publication 2 describes a polishing composition containing specific silicon oxide abrasive grains and specific cerium oxide abrasive grains and improved to increase the speed for polishing a subject polishing film and to reduce scratches. However, these polishing compositions easily cause dishing or erosion since the capacity for selectively polishing the silicon oxide film with respect to the silicon nitride film is low, and the dispersion stability is also not satisfactory.

A specific rare earth metal compound, an organic polymer compound, or an organic compound and the like with a specific functional group is added to the polishing composition as a third component, as described in, for example, Patent Publication 3 and Patent Publication 4 as a means for solving the above problems taking into consideration the use in the STI-CMP process. Among the third component, there are those having an effect for selectively forming a protective film in a concave portion of the silicon oxide film. The protective film formed by the effect of the third component functions as a polishing stopping film in the same manner as the silicon nitride film. Although such a polishing composition is actually being used in the STI-CMP process, the addition of the third component causes new problems that lowers the manufacturing efficiency of the semiconductor device such as an increase in contamination of the semiconductor device due to metal impurities and organic impurities, residual abrasive grains due to reduction in ease of washing, and reduction in ease of handling. Further, the polishing condition under which the protective film formed by the effect of the third component functions as the polishing stopping film is limited, and the protective film does not function as the polishing stopping film under the polishing condition of low pressure, high-speed rotation, which is effective in avoiding the occurrence of dishing and erosion. In addition, special effluent processing becomes necessary since the third component is mixed with a polishing effluent.

Alternatively, a technique for combining the cerium oxide abrasive grains and the silicon oxide abrasive grains to solve the above problems has also been proposed. For instance, Patent Publication 5 describes a polishing molded product formed by molding mixed powder, which is produced by mixing cerium oxide powder with silicon oxide powder. Further, Patent Publication 6 describes a polishing composition containing abrasive grains obtained by adding silicon oxide fine powder or silica sol to a solid solution of cerium oxide and silicon oxide and repeating wet milling. This polishing composition has been improved to improve surface roughness including scratches and increase capacity for selectively polishing the silicon oxide film with respect to the silicon nitride film.

However, the polished wafer cannot be easily washed since cerium oxide abrasive grains are easily adsorbed by the silicon oxide film even with the techniques disclosed in Patent Publication 5 and Patent Publication 6. Further, polishing scratches tend to be easily produced on the polished wafer surface due to hard cerium oxide abrasive grains. Moreover, surface steps produced on the polished wafer are not sufficiently suppressed.

Patent Publication 1:

Japanese Laid-Open Patent Publication No. 8-148455

Patent Publication 2:

Japanese Laid-Open Patent Publication No. 2000-336344

Patent Publication 3:

Japanese Laid-Open Patent Publication No. 2001-192647

Patent Publication 4:

Japanese Laid-Open Patent Publication No. 2001-323256

Patent Publication 5:

Japanese Laid-Open Patent Publication No. 11-216676

Patent Publication 6:

Japanese Laid-Open Patent Publication No. 10-298537

### DISCLOSURE OF THE INVENTION

It is an object of the present invention to provide a polishing composition that is optimal for use in polishing to form an element isolation structure in a semiconductor device, and to provide a polishing method using the same.

In order to achieve the above object, one aspect of the present invention provides a polishing composition containing cerium oxide abrasive grains with surfaces having an adsorption layer formed by adsorption of silicon oxide fine grains. The polishing composition is used in an application for polishing a polishing subject that includes a laminated body and a silicon oxide film arranged on the laminated body. The laminated body has a semiconductor substrate formed from a monocrystalline silicon or a polycrystalline silicon, a silicon nitride film arranged on the semiconductor substrate, and a surface with grooves. The polishing composition removes a portion of the silicon oxide film located outside the groove.

Another aspect of the present invention provides a method for polishing a polishing subject with a polishing composition. The polishing subject includes a laminated body and a silicon oxide film arranged on the laminated body. The laminated body has a semiconductor substrate formed from a monocrystalline silicon or a polycrystalline silicon, a silicon nitride film arranged on the semiconductor substrate, and a surface with grooves. The polishing composition removes a portion of the silicon oxide film located outside the groove.

### BRIEF DESCRIPTION OF THE DRAWINGS

FIG. 1(a) is a cross-sectional view of a polishing subject before being polished by a polishing composition according to one embodiment of the present invention;

FIG. 1(b) is a cross-sectional view of the polishing subject after being polished by the polishing composition according to one embodiment of the present invention; and

FIG. 2 is a graph showing the relationship between a converted polishing amount of silicon oxide film and a surface step.

### BEST MODE FOR CARRYING OUT THE INVENTION

One embodiment of the present invention will now be described with reference to the drawings.

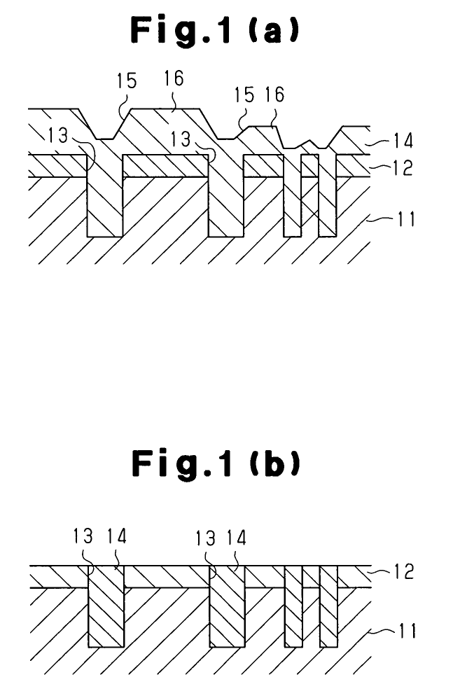

FIG. 1(a) is a cross-sectional view of a polishing subject before being polished by a polishing composition according to the present embodiment. As shown in FIG. 1(a), the polishing subject includes a silicon wafer 11, which serves as a semiconductor substrate made of monocrystalline silicon or polycrystalline silicon, a silicon nitride (Si₃N₄) film 12, which is arranged on the silicon wafer 11 and functions as a polishing stopping film, and a silicon oxide (SiO₂) film 14, which is arranged on the silicon nitride film 12 and functions as an insulating film. The silicon nitride film 12 and the silicon oxide film 14 are each formed through the CVD method. A laminated body formed by the silicon wafer 11 and the silicon nitride film 12 has a surface including grooves 13. The silicon oxide film 14 is formed on the laminated body that includes the grooves 13 through the CVD method. Thus, the portions of the silicon oxide film 14 corresponding to the grooves 13 is depressed so as to form recesses 15, and the portions of the silicon oxide film 14 that do not correspond to the groove 13 is projected so as to form projections 16.

FIG. 1(b) shows a cross-sectional view of the polishing subject after being polished by the polishing composition according to the present embodiment. The surface of the polishing subject after being polished is planar, as shown in FIG. 1(b). The polishing subject changes from the state shown in FIG. 1(a) to the state shown in FIG. 1(b) by removing the portion of the silicon oxide film 14 located outside the grooves 13. This forms an element isolation structure. The portions of the silicon oxide film 14 remaining in the grooves 13 without being removed through the polishing function as isolation regions.

The polishing composition of the present embodiment is used in the STI-CMP process as described above. The polishing composition of the present embodiment has a feature in which it contains cerium oxide (CeO₂) abrasive grains covered by a single adsorption layer made of silicon oxide fine grains. The polishing composition preferably contains water functioning as a dispersion medium.

Most of the polishing compositions conventionally used in the ILD-CMP process or the STI-CMP process contain silicon oxide abrasive grains. Further, silicon oxide abrasive grains are used more often than any other abrasive grains in the manufacturing step of the semiconductor device. This is because the possibility of different types of impurities remaining on the polished wafer surface can be reduced since the component of the silicon oxide abrasive grains and the component of the silicon wafer are the same. Further, the extent of scratches on the polished wafer surface or the dispersion stability of the water dispersions of the silicon oxide abrasive grains are within tolerable limits. Silicon oxide abrasive grains have the capability to rapidly polish the silicon oxide film and have a high capability for selectively polishing the silicon oxide film with respect to the silicon nitride film. That is, the silicon oxide abrasive grains have the features of high polishing selectivity and high polishing speed. The cerium oxide abrasive grains, of which surface adsorbs silicon oxide fine grains, contained in the polishing composition of the present embodiment have the advantages of both silicon oxide abrasive grains and cerium oxide abrasive grains.

Cerium oxide abrasive grains covered by a layer of silicon oxide fine grains are commercially available. However, when using such commercially available cerium oxide abrasive grains as abrasive grains for a polishing composition, only the aspect of the silicon oxide abrasive grains is exhibited, and high polishing selectivity and high polishing speed, which are the features of the cerium oxide abrasive grains, are not exhibited at all. This is considered to be because the cerium oxide abrasive grains do not act on the polishing subject during polishing since the layer of silicon oxide fine grains covering the surface of the cerium oxide abrasive grains is very rigid. High polishing selectivity and high polishing speed, which are the features of the cerium oxide abrasive grain, are exhibited when the surface of the cerium oxide abrasive grain selectively produce solid surface reaction with the surface of the silicon oxide film. It is important that the solid surface reaction selectively occurs at the projections 16 rather than at the recesses 15 in order to polish the surface of the polishing subject to be planar. In order to enhance dispersion stability and handling of the polishing composition, the silicon oxide fine grains must stably be adsorbed in the surface of the cerium oxide abrasive grains at least when polishing is not being performed.

In view of the above, it is desirable that the layer of silicon oxide fine grains that covers the surface of the cerium oxide abrasive grains not be too rigid. That is, it is desirable that the surface of the cerium oxide abrasive grains be exposed to act on the polishing subject when the polishing pressure is greater than or equal to a predetermined value, and that the surface of the cerium oxide abrasive grains be covered by the silicon oxide fine grains and the surface of the cerium oxide abrasive grain not be exposed when the polishing pressure is lower than the predetermined value. It is desirable that the capacity of the silicon oxide fine grains that covers the surface of the cerium oxide abrasive grains for polishing the silicon oxide film not be very high. The capacity of the silicon oxide fine grains for polishing the silicon oxide film decreases as the grain diameter decreases. Further, the silicon oxide fine grains are more stably adsorbed in the surface of the cerium oxide as the grain diameter decreases.

The cerium oxide abrasive grains contained in the polishing composition of the present embodiment are covered by the adsorption layer of silicon oxide fine grains. The adsorption layer is not that rigid since it is formed by adsorbing the silicon oxide fine grains in the cerium oxide abrasive grains in a surface potential manner. Since the adsorption layer is made of silicon oxide, the polishing composition containing the cerium oxide abrasive grains covered by the adsorption layer has dispersion stability and ease of washing that are the same as slurry, which is conventionally used in the ILD-CMP process.

The polishing composition of the present embodiment is prepared, for example, by dispersing cerium oxide abrasive grains and silicon oxide fine grains in water. When the cerium oxide abrasive grains and the silicon oxide fine grains are dispersed in water, the silicon oxide fine grains are naturally adsorbed to the surface of the cerium oxide abrasive grains. As a result, the cerium oxide abrasive grains are partially or entirely covered by the adsorption layer of silicon oxide fine grains.

The cerium oxide abrasive grains are prepared by wet milling cerium oxide having a purity of 3N and manufactured by SHIN-ETSU CHEMICAL Co., Ltd. using a nylon milling pot having a volume of 1040 cm³ and a zirconium milling balls having a diameter of 2 mm manufactured by CHUOU KAKOUKI KABUSHIKI KAISHA. The cerium oxide abrasive grains obtained in this manner are adjusted to a predetermined grain size (e.g., grain diameter obtained from specific surface area is 60 nm) by classification through natural sedimentation. Cerium oxide abrasive grains having a small grain size contributes to enhancement in the stability of the polishing composition. However, the capacity of polishing a polishing subject is not so high. Further, the cost required to obtain the cerium oxide abrasive grains having a small grain size is high. Cerium oxide abrasive grains having a large grain size has a high capacity for polishing the polishing subject and is superior in terms of cost but lowers the stability of the polishing composition and produces polishing scratches. Therefore, the grain diameter of the cerium oxide abrasive grains obtained from the specific surface area of the cerium oxide abrasive grain is preferably between 10 and 200 nm inclusive, and more preferably between 30 and 100 nm inclusive.

It is desirable that cerium oxide abrasive grains have crystallinity. If the cerium oxide abrasive grains have crystallinity, it is desirable that the crystallinity be as high as possible. The polishing capacity of the cerium oxide abrasive grain increases as the crystallinity becomes high. Cerium oxide abrasive grains having low crystallinity and cerium oxide abrasive grains that do not have crystallinity are appropriately baked to have high crystallinity. It is desirable that the cerium oxide have purity that is as high as possible to suppress metal contamination of the semiconductor device.

The silicon oxide fine grains may be colloidal silica or fumed silica. The colloidal silica is synthesized from, for example, tetramethoxysilane through a sol-gel process. It is desirable that the grain diameter of the silicon oxide fine grains be less than at least the grain diameter of the cerium oxide abrasive grains, and further desirable to be less than or equal to ½ of the grain diameter of the cerium oxide abrasive grains. When the grain diameter of the silicon oxide fine grains exceeds ½ of the grain diameter of the cerium oxide abrasive fine grains, the adsorption layer made of silicon oxide fine grains is less likely to form on the surface of the cerium oxide abrasive grains. The grain diameter of the silicon oxide fine grains obtained from the specific surface area of the silicon oxide fine grains is desirably less than or equal to 300 nm, more desirably between 1 and 200 nm inclusive, and most desirably between 1 and 100 nm inclusive. Silicon oxide fine grains having a grain diameter of less than 1 nm require high cost for manufacturing, and are not easy to manufacture. When the grain diameter of the silicon oxide fine grains exceeds 200 nm, the adsorption layer of silicon oxide fine grains is less likely to form on the surface of the cerium oxide abrasive grain. Further, the silicon oxide fine grains having an excessively large grain diameter have a high capacity for polishing a silicon nitride film. This lowers the capability for selectively polishing the silicon oxide film with respect to the silicon nitride film.

The content of the cerium oxide abrasive grains in the polishing composition is preferably between 0.1 and 10% by mass inclusive. The polishing composition in which the content of the cerium oxide abrasive grains is less than 0.1% by mass does not have a high capacity for polishing the silicon oxide film. When the content of the cerium oxide abrasive grain exceeds 10% by mass, polishing scratches and surface steps tend to form on the polishing subject subsequent to polishing.

The content of the silicon oxide fine grains in the polishing composition is preferably between 0.1 and 15% by mass inclusive. When the content of the silicon oxide fine grains is less than 0.1% by mass, the adsorption layer made of silicon oxide fine grains is less likely to form on the surface of the cerium oxide abrasive grains. When the content of the silicon oxide fine grains exceeds 15% by mass, the effect of the cerium oxide abrasive grains is inhibited since a large amount of silicon oxide fine grains are let free and exist in the polishing composition. Consequently, the polishing selectivity and the polishing speed of the polishing composition may be lowered.

The ratio of the total mass of the silicon oxide fine grains contained in the polishing composition with respect to the total mass of the cerium oxide abrasive grain contained in the polishing composition is preferably between 0.1 and 10 inclusive, more preferably between 0.5 and 5 inclusive, and most preferably between 1 and 3 inclusive. When the ratio is less than 0.1, the effect of the silicon oxide fine grains may not be sufficiently exhibited since the adsorption layer of silicon oxide fine grains is not sufficiently formed on the surface of the cerium oxide abrasive grains. When the ratio exceeds 10, the effect of the cerium oxide abrasive grain is not sufficiently exhibited since a large amount of silicon oxide fine grains are let free and exist in the polishing composition.

Cerium oxide abrasive grains having a grain diameter of 60 nm obtained from the specific surface area and silicon oxide fine grains having a grain diameter of 10 nm obtained from the specific surface area were dispersed in super pure water to prepare a polishing composition containing 1% by mass of cerium oxide abrasive grain and 1% by mass of silicon oxide fine grains. When the properties of the polishing composition containing both the cerium oxide abrasive grains and the silicon oxide fine grains were checked, the stability was high and the capacity to reduce steps produced on the polishing subject after polishing was high compared to a polishing composition containing, among cerium oxide abrasive grains and silicon oxide fine grains, only cerium oxide abrasive grains. The polishing speed of the polishing composition containing both cerium oxide abrasive grains and the silicon oxide fine grains was between ½ to ⅓ inclusive of the polishing speed of the polishing composition containing only cerium oxide abrasive grains but was about the same as the polishing speed of the commercially available fumed silica base polishing composition generally used in the ILD-CMP process.

After repeating a series of operations for centrifugalizing the above described polishing composition containing both the cerium oxide abrasive grains and the silicon oxide fine grains, that is, the above described polishing composition containing composite abrasive grains of silicon oxide and cerium oxide and dispersing again the sedimentation cake generated in the polishing composition over a number of times, the sedimentation cake only contained, among cerium oxide abrasive grains and silicon oxide fine grains, only the cerium oxide abrasive grains and not the silicon oxide fine grains. When a similar operation was performed using a polishing composition containing the commercially available cerium oxide abrasive grains covered with silicon oxide fine grains, the sedimentation cake contained the silicon oxide fine grains and the cerium oxide abrasive grains, and the ratio of the silicon oxide fine grains and the cerium oxide abrasive grains in the sedimentation cake was exactly the same as the ratio of the silicon oxide fine grains and the cerium oxide abrasive grains in the polishing composition. The above result suggests that the layer made of silicon oxide fine grains for covering the surface of the cerium oxide abrasive grains in the composite abrasive grain according to the present embodiment is not as rigid as the layer of silicon oxide fine grains that covers the surface of the cerium oxide abrasive grains in the commercially available composite abrasive grains. In other words, this suggests that the composite abrasive grains of the silicon oxide and the cerium oxide in the present embodiment have a completely different aspect compared to the commercially available composite abrasive grains.

A polishing method using the polishing composition of the present embodiment will now be described.

As discussed above, the polishing composition of the present embodiment is used to polish the polishing subject shown in FIG. 1(a) and remove portions of the silicon oxide film 14 located outside the groove 13. During the polishing, the polishing pad is pressed against the surface of the polishing subject while the polishing composition is supplied to the polishing pad, and at least either one of the polishing pad and the polishing subject is slidably moved with respect to the other one. The polishing pad pressed against the surface of the polishing subject only contacts, among the recesses 15 and the projections 16 on the surface of the polishing subject, only the projections 16 and does not contact the recesses 15 in an initial polishing stage. Therefore, a relatively high polishing pressure acts on the projections 16 in the initial stage of polishing. When the polishing pressure is high, as mentioned above, the composite abrasive grain in the polishing composition dissociates into the cerium oxide abrasive grain and the silicon oxide fine grains thereby exposing the surface of the cerium oxide abrasive grain. The projections 16 are thus polished at a high polishing speed in the initial polishing stage.

The projections 16 eventually become eliminated as the polishing progresses. The polishing pressure acting on the polishing subject is dispersed since the area of the surface of the polishing subject contacting the polishing pad increases as the projections 16 become eliminated. Due to the lowering in polishing pressure, the cerium oxide abrasive grains in the polishing composition are again covered by the silicon oxide fine grains. The composite abrasive grains formed by covering the cerium oxide abrasive grains with the silicon oxide fine grains have the capacity to polish the silicon oxide film 14 with a higher selectivity with respect to the silicon nitride film 12 compared to the cerium oxide abrasive grains. The production of polishing scratches and surface steps and the occurrence of dishing and erosion at the surface of the polishing subject after polishing are thus suppressed. Further, since the composite abrasive grains have lower adsorption with respect to the silicon oxide film 14 compared to cerium oxide abrasive grains, the abrasive grains attached to the polishing subject after polishing are easily removed by washing the polishing subject with water.

The present embodiment has the advantages described below.

The polishing composition of the present embodiment contains cerium oxide abrasive grains covered by an adsorption layer of silicon oxide fine grains. Thus, the step of polishing the polishing subject shown in FIG. 1(a) using the polishing composition includes an initial stage in which the polishing subject is polished by the effect of the cerium oxide abrasive grains and a latter stage in which the polishing subject is polished by the effect of the silicon oxide fine grains. Therefore, the functions of both the cerium oxide abrasive grains and the silicon oxide fine grains are effectively exhibited based on the polishing pressure. The polishing composition of the present embodiment is thus effective in polishing for forming an element isolation structure in a semiconductor device. That is, the polishing composition of the present embodiment contributes to facilitated and efficient formation of the isolation structure in the semiconductor device and also contributes to enhancement in yield and reduction in manufacturing cost of the semiconductor device.

When the ratio of the total mass of the silicon oxide fine grains contained in the polishing composition with respect to the total mass of the cerium oxide abrasive grains contained in the polishing composition is between 0.1 and 10 inclusive, the adsorption layer of silicon oxide fine grains is optimally formed on the surface of the cerium oxide abrasive grains. This particularly obtains useful composite abrasive grains.

When the grain diameter of the cerium oxide abrasive grains in the polishing composition is between 10 and 200 nm inclusive and the grain diameter of the silicon oxide fine grains in the polishing composition is between 1 and 200 nm inclusive, or when the grain diameter of the silicon oxide fine grains in the polishing composition is less than the grain diameter of the cerium oxide abrasive grains, the adsorption layer of silicon oxide fine grains is optimally formed on the surface of the cerium oxide abrasive grains. This particularly obtains useful composite abrasive grains.

The polishing composition of the present embodiment does not contain organic compounds. Thus, a process for reducing the chemical oxygen demand (COD) and the biological oxygen demand (BOD) during disposal is unnecessary. This facilitates the effluent process.

The present invention will now be discussed in further detail using examples and comparative examples.

Cerium oxide abrasive grains were prepared by wet milling cerium oxide having a purity of 3N manufactured by SHIN-ETSU CHEMICAL Co., Ltd. using a nylon milling pot having a volume of 1040 cm³ and zirconia milling balls having a diameter of 2 mm manufactured by CHUOU KAKOUKI KABUSHIKI KAISHA. The prepared cerium oxide abrasive grains were classified by natural sedimentation, and the grain size of the cerium oxide abrasive grains was adjusted so as to have a grain diameter obtained from the specific surface area in a range of 60 to 360 nm. In addition, the high purity colloidal silica was synthesized from tetramethoxysilane through the sol-gel method. The grain size of the synthesized colloidal silica was adjusted so as to have the grain size obtained from the specific surface area in a range of 10 to 90 nm. The polishing composition of examples 1 to 57 and comparative examples 1 to 5 were produced by mixing cerium oxide abrasive grains and colloidal silica (silicon oxide fine grains) in super pure water. Further, in comparative example 6, the polishing composition “PLANERLITE-4218” manufactured by FUJIMI INCORPORATED containing the silicon oxide fine grains was prepared as the polishing composition of comparative example 6. The capacities of the polishing composition in examples 1 to 57 and comparative examples 1 to 5 were measured and evaluated as described below. The result of measurement and evaluation are shown in table 1 and table 2.

A silicon wafer having a silicon oxide film and a silicon wafer having a silicon nitride film were each polished using the CMP device “EPO-113D” manufactured by EBARA CORPORATIONS, under conditions in which the polishing load was 34.5 kPa (5.0 psi), the linear velocity of polishing was 42 m/min., and the flow rate of the polishing composition of 200 mL/min. The speed (SiO₂ polishing speed) at which the silicon wafer with the silicon oxide film was polished and the speed (Si₃N₄ polishing speed) at which the silicon wafer with the silicon nitride film was polished with each polishing composition were measured. Further, the SiO₂ polishing speed was divided by the Si₃N₄ polishing speed to calculate the ratio (polishing selecting ratio) of the two to measure the capacity of the polishing composition to selectively polish the silicon oxide film with respect to the silicon nitride film.

Subsequent to the polishing, the wafer having the silicon oxide film underwent brush scrub washing using polyvinyl alcohol (PVA) and ultrasonic rinse washing using super pure water. The number of defects having the size of 0.2 μm or greater on the wafer surface that had been washed was measured using “SURFSCAN SPL-TBI” manufactured by KLA TENCOR CORPORATION. The ease of washing of each polishing composition was evaluated based on four ranks in accordance with the number of measured defects, in which a cross indicates that the number of defects is greater than or equal to 500, a triangle indicates that the number of defects is greater than or equal to 150 but less than 500, a single circle indicates that the number of defects is greater than or equal to 50 but less than 150, and a double circle indicates that the number of defects is less than 50.

The silicon wafer with the silicon oxide film that has been washed was further rinse-washed for 12 seconds with 0.5% by mass of hydrofluoric acid aqueous solution, and the number (X1) of defects having a size of 0.2 μm or greater on the washed wafer surface was measured using the “SURFSCAN SP1-TBI”. Thereafter, the silicon wafer with the silicon oxide film was further rinse-washed for 200 seconds with hydrofluoric acid aqueous solution, and the number (X2) of defects having a size of 0.2 μm or greater on the washed wafer surface was measured using “SURFSCAN SP1-TBI”. Based on a calculation equation of Y=(X2−X1)/200, the value Y was calculated. The occurrence state of polishing scratches on the wafer that has been polished using each polishing composition was evaluated based on four ranks based on the value of the calculated value Y, in which a cross indicates that the value Y was greater than or equal to 0.45, a triangle indicates that the value Y was greater than or equal to 0.30 but less than 0.45, a single circle indicates that the value Y was greater than or equal to 0.15 but less than 0.30, and a double circle indicates that the value Y was less than 0.15.

A commercially available wide opening polyethylene bottle having a volume of 1000 mL and filled with 1000 mL of each polishing composition was left to stand under a temperature atmosphere of 80° C. After left standing for six hours, the portion (500 mL) of the polishing composition at the upper half of the polyethylene bottle was separated through suction. The silicon wafer with the silicon oxide film was polished using the separated upper half of the polishing composition, and the speed (SiO₂ polishing speed) at which the wafer was polished was measured. The sedimentation stability of each polishing composition was evaluated based on four ranks, in which a cross indicates that the measured SiO₂ polishing speed was less than or equal to 50% of the previously described SiO₂ polishing speed of the polishing composition, a triangle indicates that the measured SiO₂ polishing speed was greater than or equal to 50% and less than 70%, a single circle indicates that the measured SiO₂ polishing speed was greater than or equal to 70% but less than 90%, and a double circle indicates that the measured SiO₂ polishing speed was greater than or equal to 90%.

The polyethylene bottle in which the portion (500 mL) of the polishing composition at the lower half remained after suction of the upper half of the polishing composition was quietly reversed, and the area of the sedimentation cake remaining at the bottom of the bottle was measured. The redispersibility of each polishing composition was evaluated based on four ranks, in which a cross indicates that the measured area of the sedimentation cake was 80% or greater than the bottom of the bottle, a triangle indicates that the measured area of the sedimentation cake was 50% or greater than but less than 80%, a single circle indicates that the measured area of the sedimentation cake was 20% or greater but less than 50%, and a double circle indicates less than 20%.

A commercially available SEMATECH SKW3 pattern wafer (polishing subject shown in FIG. 1(a)) was polished using the CMP device “EPO-113D” manufactured by EBARA CORPORATION under conditions in which the polishing load was 34.5 kPa (5.0 psi), the linear velocity of polishing was 42 m/min., and the flow rate of the polishing composition was 200 mL/min. The thickness of the portion of the silicon oxide film corresponding to the projections on the surface of the pattern wafer was originally 7000 Å and polishing was finished at the point when the thickness was reduced to 2000 Å through polishing. After polishing, surface steps on portions of the wafer where element portions having a width of 50 μm and insulation portions having a width of 50 μm were arranged in a continuously repetitive manner were measured using “HRP-340” manufactured by KLA TENCOR CORPORATION. The step reducing capacity of each polishing composition was evaluated based on four ranks, in which a cross indicates that the measured surface steps were reduced by 50% or less of the initial step (5000 Å), a triangle indicates that the measured surface steps were reduced by 50% or greater but less than 70%, a single circle indicates that the measured surface steps were reduced by 70% or greater but less than 90%, and a double circle indicates that the measured surface steps were reduced by 90% or greater.

TABLE 1

| | CeO₂ | CeO₂ | SiO₂ | SiO₂ | SiO₂ | Si₃N₄ | | Ease | Occurrence | Sedi- | | Step |
|---|---|---|---|---|---|---|---|---|---|---|---|---|
| | grain | con- | grain | con- | polishing | polishing | Polishing | of | state of | men- | | re- |
| | diameter | centration | diameter | centration | speed | speed | selectivity | wash- | polishing | tation | | ducing |
| | (nm) | (mass %) | (nm) | (mass %) | (Å/min) | (Å/min) | ratio | ing | scratches | stability | Redispersibility | capacity |
| C. Ex. 1 | 60 | 0.5 | — | 0.0 | 4710 | 435 | 10.8 | X | Δ | X | X | Δ |
| Ex. 1 | | | 10 | 0.5 | 2288 | 186 | 12.3 | ◯ | ◯ | ◯ | ⊚ | ◯ |
| Ex. 2 | | | | 2.0 | 1568 | 195 | 8.0 | ⊚ | ◯ | ⊚ | ⊚ | ◯ |
| Ex. 3 | | | | 5.0 | 1460 | 209 | 7.0 | ⊚ | ◯ | ⊚ | ⊚ | ◯ |
| Ex. 4 | | | 30 | 0.5 | 2765 | 325 | 8.5 | ◯ | ◯ | ◯ | ⊚ | ◯ |
| Ex. 5 | | | | 2.0 | 2180 | 259 | 8.4 | ⊚ | ◯ | ◯ | ⊚ | ◯ |
| Ex. 6 | | | | 5.0 | 1985 | 260 | 7.6 | ⊚ | ◯ | ⊚ | ⊚ | ◯ |
| Ex. 7 | | | 90 | 0.5 | 4537 | 404 | 11.2 | ◯ | ◯ | Δ | ◯ | ◯ |
| Ex. 8 | | | | 2.0 | 2825 | 297 | 9.5 | ⊚ | ◯ | Δ | ◯ | ⊚ |
| Ex. 9 | | | | 5.0 | 2108 | 319 | 6.6 | ⊚ | ◯ | Δ | ◯ | ⊚ |
| C. Ex. 2 | | 1.0 | — | 0.0 | 5900 | 780 | 7.6 | X | Δ | Δ | X | X |
| Ex. 10 | | | 10 | 0.5 | 3639 | 334 | 10.9 | ◯ | ⊚ | ◯ | ◯ | ◯ |
| Ex. 11 | | | | 2.0 | 2947 | 292 | 10.1 | ⊚ | ⊚ | ⊚ | ⊚ | ⊚ |
| Ex. 12 | | | | 5.0 | 2198 | 315 | 7.0 | ⊚ | ⊚ | ⊚ | ⊚ | ⊚ |
| Ex. 13 | | | 30 | 0.5 | 4281 | 396 | 10.8 | ◯ | ⊚ | ◯ | ◯ | ◯ |
| Ex. 14 | | | | 2.0 | 3896 | 429 | 9.1 | ⊚ | ⊚ | ◯ | ⊚ | ◯ |
| Ex. 15 | | | | 5.0 | 3447 | 485 | 7.1 | ⊚ | ⊚ | ◯ | ⊚ | ◯ |
| Ex. 16 | | | 90 | 0.5 | 5858 | 606 | 9.7 | ◯ | ◯ | X | Δ | ⊚ |
| Ex. 17 | | | | 2.0 | 4317 | 618 | 7.0 | ⊚ | ◯ | Δ | ◯ | ⊚ |
| Ex. 18 | | | | 5.0 | 3850 | 599 | 6.4 | ⊚ | ◯ | Δ | ◯ | ⊚ |
| C. Ex. 3 | | 3.0 | — | 0.0 | 7471 | 1230 | 6.1 | X | Δ | Δ | X | X |
| Ex. 19 | | | 10 | 0.5 | 5556 | 842 | 6.6 | ◯ | ◯ | Δ | ◯ | ◯ |
| Ex. 20 | | | | 2.0 | 4929 | 730 | 6.8 | ◯ | ◯ | Δ | ◯ | ◯ |
| Ex. 21 | | | | 5.0 | 4410 | 716 | 6.2 | ⊚ | ◯ | Δ | ⊚ | ⊚ |
| Ex. 22 | | | 30 | 0.5 | 6099 | 875 | 7.0 | ◯ | ◯ | X | ◯ | Δ |
| Ex. 23 | | | | 2.0 | 5394 | 873 | 6.2 | ◯ | ◯ | X | ◯ | Δ |
| Ex. 24 | | | | 5.0 | 4370 | 861 | 5.1 | ⊚ | ◯ | Δ | ⊚ | ◯ |
| Ex. 25 | | | 90 | 0.5 | 7136 | 1005 | 7.1 | ◯ | ◯ | X | Δ | Δ |
| Ex. 26 | | | | 2.0 | 5826 | 1030 | 5.7 | ◯ | ◯ | X | Δ | Δ |
| Ex. 27 | | | | 5.0 | 5634 | 1155 | 4.9 | ⊚ | ◯ | Δ | ◯ | ◯ |

TABLE 2

| | CeO₂ | CeO₂ | SiO₂ | SiO₂ | SiO₂ | Si₃N₄ | | Ease | Occurrence | Sedi- | | Step |
|---|---|---|---|---|---|---|---|---|---|---|---|---|
| | grain | con- | grain | con- | polishing | polishing | Polishing | of | state of | men- | | re- |
| | diameter | centration | diameter | centration | speed | speed | selectivity | wash- | polishing | tation | | ducing |
| | (nm) | (mass %) | (nm) | (mass %) | (Å/min) | (Å/min) | ratio | ing | scratches | stability | Redispersibility | capacity |
| Ex. 28 | 110 | 0.5 | 10 | 0.5 | 2494 | 223 | 11.2 | ◯ | ◯ | X | ◯ | ◯ |
| Ex. 29 | | | | 2.0 | 2385 | 234 | 10.2 | ⊚ | ◯ | Δ | ◯ | ◯ |
| Ex. 30 | | | | 5.0 | 2147 | 341 | 6.3 | ⊚ | ◯ | ◯ | ⊚ | ◯ |
| Ex. 31 | | | 30 | 0.5 | 3173 | 261 | 12.2 | ◯ | ◯ | X | ◯ | Δ |
| Ex. 32 | | | | 2.0 | 2798 | 283 | 9.9 | ⊚ | ◯ | X | ◯ | ◯ |
| Ex. 33 | | | | 5.0 | 2583 | 397 | 6.5 | ⊚ | ◯ | Δ | ⊚ | ◯ |
| Ex. 34 | | | 90 | 0.5 | 4368 | 325 | 13.4 | ◯ | ◯ | X | ◯ | ◯ |
| Ex. 35 | | | | 2.0 | 3238 | 337 | 9.6 | ⊚ | ◯ | X | ◯ | ◯ |
| Ex. 36 | | | | 5.0 | 2684 | 468 | 5.7 | ⊚ | ◯ | Δ | ⊚ | ◯ |
| C. Ex. 4 | | 1.0 | — | 0.0 | 6251 | 743 | 8.4 | X | Δ | X | X | X |
| Ex. 37 | | | 10 | 0.5 | 4125 | 371 | 11.1 | ◯ | ◯ | Δ | Δ | ◯ |
| Ex. 38 | | | | 2.0 | 3299 | 387 | 8.5 | ⊚ | ◯ | Δ | ◯ | ⊚ |
| Ex. 39 | | | | 5.0 | 3148 | 453 | 6.9 | ⊚ | ◯ | ◯ | ⊚ | ⊚ |
| Ex. 40 | | | 30 | 0.5 | 4410 | 428 | 10.3 | ◯ | ◯ | X | Δ | ◯ |
| Ex. 41 | | | | 2.0 | 3859 | 471 | 8.2 | ⊚ | ◯ | Δ | ◯ | ◯ |
| Ex. 42 | | | | 5.0 | 3509 | 575 | 6.1 | ⊚ | ◯ | ◯ | ⊚ | ◯ |
| Ex. 43 | | | 90 | 0.5 | 4797 | 519 | 9.2 | ◯ | ◯ | X | Δ | ◯ |
| Ex. 44 | | | | 2.0 | 5006 | 643 | 7.8 | ⊚ | ◯ | X | Δ | ◯ |
| Ex. 45 | | | | 5.0 | 4101 | 697 | 5.9 | ⊚ | ◯ | Δ | ◯ | ⊚ |
| Ex. 46 | | 3.0 | 10 | 0.5 | 6444 | 653 | 9.9 | ◯ | ◯ | X | Δ | ◯ |
| Ex. 47 | | | | 2.0 | 5802 | 690 | 8.4 | ◯ | ◯ | Δ | Δ | ⊚ |
| Ex. 48 | | | | 5.0 | 5317 | 921 | 5.8 | ⊚ | ◯ | Δ | ◯ | ⊚ |
| Ex. 49 | | | 30 | 0.5 | 7692 | 751 | 10.2 | Δ | ◯ | X | Δ | Δ |
| Ex. 50 | | | | 2.0 | 7065 | 821 | 8.6 | ◯ | ◯ | Δ | Δ | ◯ |
| Ex. 51 | | | | 5.0 | 6857 | 1247 | 5.5 | ⊚ | ◯ | Δ | Δ | ◯ |
| Ex. 52 | | | 90 | 0.5 | 8711 | 799 | 10.9 | Δ | ◯ | X | Δ | Δ |
| Ex. 53 | | | | 2.0 | 8031 | 914 | 8.8 | ◯ | ◯ | X | Δ | ◯ |
| Ex. 54 | | | | 5.0 | 7076 | 1386 | 5.1 | ⊚ | ◯ | Δ | Δ | ◯ |
| Ex. 55 | 360 | 0.5 | 10 | 2.0 | 979 | 146 | 6.7 | ◯ | ◯ | X | Δ | ◯ |
| C. Ex. 5 | | 1.0 | — | 0.0 | 3444 | 180 | 19.1 | X | X | X | X | X |
| Ex. 56 | | | 10 | 2.0 | 2050 | 349 | 5.9 | ◯ | ◯ | X | Δ | ◯ |
| Ex. 57 | | 3.0 | 10 | 2.0 | 4421 | 670 | 6.6 | ◯ | ◯ | X | Δ | ⊚ |

| | | | | | | | | | |
|---|---|---|---|---|---|---|---|---|---|
| C. Ex. 6 | PLANERLITE-4218 | 2873 | 1403 | 2.0 | — | — | — | — | — |

As shown in table 1 and table 2, the polishing selectivity in examples 1 to 57 was greater than or equal to 5, which was a high value compared to comparative example 6. Further, the evaluation of the ease of washing, the occurrence state of the polishing scratches, and the step reducing capacity were all satisfactory in examples 1 to 57. Contrastingly, the evaluations of the above were not satisfactory in comparative examples 1 to 5. With regards to the sedimentation stability, some of examples 1 to 57 were found to be unsatisfactory. However, redispersibility during redispersing was satisfactory. Contrastingly, the redispersibility is not satisfactory in all of comparative examples 1 to 5.

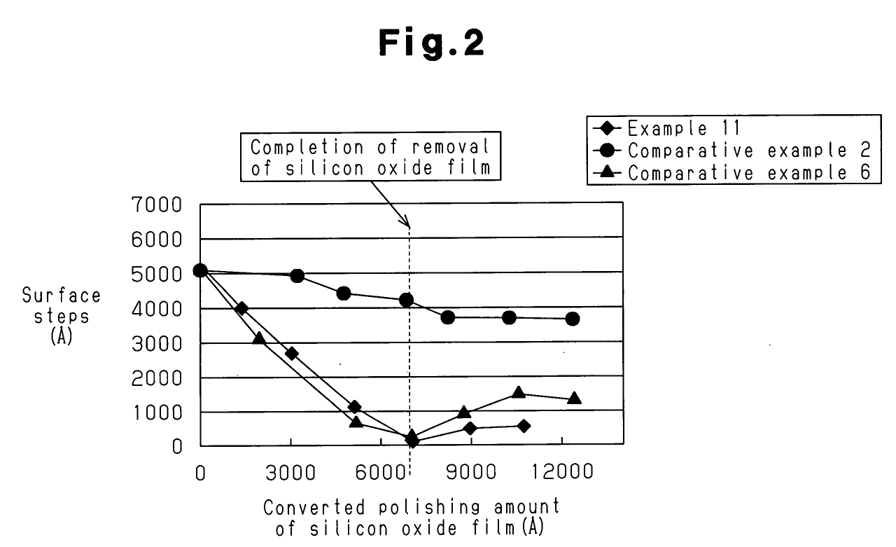

The polishing of a SEMATECH SKW3 pattern wafer was performed for a number of times using each of the polishing composition of example 11, comparative example 2, and comparative example 6. The surface steps were measured for each polishing, and the results shown in FIG. 2 were obtained by observing changes in the surface steps through polishing. As shown in FIG. 2, initial steps were not reduced much in comparative example 2. In comparative example 6, steps gradually increased after completing the removal of the silicon oxide film. In example 11, initial steps were reduced in a satisfactory manner, and steps did not greatly increase even after completing the removal of the silicon oxide film. That is, in the polishing composition of example 11, the silicon nitride film properly functioned as the polishing stopping film. This is effective in suppressing the occurrence of dishing. Since the polishing composition of comparative example 6 has low polishing selectivity, if polishing is further continued after completing the removal of silicon oxide film, a large amount of silicon nitride film will be polished, thereby causing erosion. However, the polishing composition of example 11 has a high polishing selectivity of 10 or greater. Thus, the possibility of erosion occurring is small.

The above embodiment may be modified as described below.

The polishing composition may be prepared by diluting a stock solution with water of 1 to 2 times the amount of the stock solution. The content of the cerium oxide abrasive grains in the concentrate solution is desirably between 0.3 and 15% by mass inclusive. In this case, transportation and storage are facilitated.

The adsorption layer of silicon oxide fine grains for covering the surface of the cerium oxide abrasive grain may be in multi-layers or may be a mixture of a single layer portion and a multi-layer portion.

The percentage of the period during which the polishing subject is polished by the effect of the cerium oxide abrasive grains and the period in which the polishing subject is polished by the effect of the silicon oxide fine grains may be appropriately changed by adjusting the polishing pressure during polishing.

1. A polishing composition used in an application for polishing a polishing subject including a laminated body and a silicon oxide film arranged on the laminated body, the laminated body having a semiconductor substrate formed from a monocrystalline silicon or a polycrystalline silicon, a silicon nitride film arranged on the semiconductor substrate, and a surface with grooves, wherein the polishing composition removes a portion of the silicon oxide film located outside the groove, the polishing composition comprising cerium oxide abrasive grains with surfaces having an adsorption layer formed by adsorption of silicon oxide fine grains.

2. The polishing composition according to claim 1, wherein the ratio of the total mass of the silicon oxide fine grains in the polishing composition relative to the total mass of the cerium oxide abrasive grains in the polishing composition is between 0.1 and 10 inclusive.

3. The polishing composition according to claim 1, wherein the silicon oxide fine grains have a grain diameter of 1 to 200 nm, and the cerium oxide abrasive grains have a grain diameter of 10 to 200 nm.

4. The polishing composition according to claim 1 wherein the grain diameter of the silicon oxide fine grains is smaller than the grain diameter of the cerium oxide abrasive grains.

5. The polishing composition according to claim 1, wherein the cerium oxide abrasive grains have crystallinity.

6. A method for polishing a polishing subject including a laminated body and a silicon oxide film arranged on the laminated body, the laminated body having a semiconductor substrate formed from a monocrystalline silicon or a polycrystalline silicon, a silicon nitride film arranged on the semiconductor substrate, and a surface with grooves, the method comprising:
preparing a polishing composition by dispersing cerium oxide abrasive grains and silicon dioxide fine grains in water; and
using the prepared polishing composition to polish the polishing subject, wherein the polishing composition removes a portion of the silicon oxide film located outside the groove.

7. A stock solution for a polishing composition diluted with water, the stock solution comprising cerium oxide abrasive grains with surfaces having an adsorption layer formed by adsorption of silicon oxide fine grains.
